(19) United States
(12) Patent Application Publication
(10) Pub. No.: US 2011/0056901 A1
(43) Pub. Date: Mar. 10, 2011

(54) TRANSFER APPARATUS AND TRANSFER METHOD

(75) Inventors: Tsuyoshi KUMAZAWA, Inuyama-shi (JP); Masaru HATTORI, Inuyama-shi (JP); Takeshi MURAKAMI, Kyoto-shi (JP)

(73) Assignee: MURATA MACHINERY, LTD., Kyoto-shi (JP)

(21) Appl. No.: 12/874,351

(22) Filed: Sep. 2, 2010

(30) Foreign Application Priority Data
Sep. 9, 2009 (JP) 2009-207880

(51) Int. Cl. B66C 13/18

(52) U.S. Cl. 212/276

(57) ABSTRACT

In a transfer apparatus, a SCARA arm is provided on an elevation platform. Further, a sensor arranged to detect inclination at a tip end of the arm and a sensor arranged to measure a position of an article on the arm are provided. A base is tilted to eliminate inclination of the detected inclination, and a stretching amount of the arm is corrected in correspondence with the measured position of the article on the arm.

### BACKGROUND OF THE INVENTION

1. Field of the Invention

The present invention relates to a transfer apparatus. In particular, the present invention relates to a transfer apparatus capable of unloading an article to a predetermined position without any inclination of an arm at a time of stretching the arm.

2. Description of the Related Art

The applicant proposed to attach an optical sensor to a tip end of an arm of a slide fork or the like, for reading a mark near a support member to correct inclination of the arm. See, for example, JP 2006-219233A. However, in the case of reading the mark near the support member, areas where inclination can be detected are limited to narrow ranges immediately before a loading position and immediately before an unloading position. In other positions, inclination can only be corrected by means of an open loop control in accordance with a stored pattern. Under such circumstances, since inclination of the arm cannot be corrected sufficiently at the time of unloading the article, the article may contact a guide near the support member, and the article may be unloaded to a position shifted from an intended position. Further, since no sensor is provided for measuring a position of the article in a length direction of the arm, at the time of unloading the article, the guide may easily contact the article to cause a further shift of the unloading position of the article.

### SUMMARY OF THE INVENTION

Preferred embodiments of the present invention make it possible to transfer an article while keeping a tip end of an arm horizontal, and to unload the article to a more correct position.

In addition, preferred embodiments of the present invention make it possible to measure inclination regardless of a position in an elevation direction of the arm, without requiring any marks or the like at the destination of transfer of the article.

Also, preferred embodiments of the present invention provide a specific method of unloading an article to a correct position quietly.

According to a preferred embodiment of the present invention, a transfer apparatus includes a tiltable base, an arm arranged to be elevated, lowered, stretched, and retracted on the base, a sensor arranged to detect inclination at a tip end of the arm, a sensor arranged to measure a position of an article on the arm, and a controller arranged to tilt the base to cancel a detected inclination and to correct a stretching amount of the arm in correspondence with a measured position of the article on the arm.

In this manner, by tilting the base, inclination at the tip end of the arm can be eliminated. At the time of unloading the article, collision between the arm and the guide at the unloading position due to inclination of the arm can be prevented. Further, by eliminating inclination at the tip end of the arm, the elevation distance of the arm required to load and unload the article can be shortened. Further, by measuring the position of the article on the arm, the unloading position is corrected in correspondence with the position of the article. Therefore, also in this respect, collision with the guide or the like is prevented, and the article can be unloaded to the correct position. Thus, the article can be transferred to the correct position quietly.

Preferably, as a sensor to detect the inclination, an inclination sensor to detect inclination of a moving element due to the gravity is provided at the tip end of the arm. In this manner, inclination at the tip end of the arm can be detected in a wide range regardless of the position in the elevation direction of the arm. Further, no marks or the like are required at the destination of the transfer of the article.

Further, preferably, the controller is configured to stretch the arm in correspondence with the position of the article on the arm at the time of unloading of the article, tilt the base in accordance with a stored tilt angle during stretching of the arm, and lower the arm while tilting the base in accordance with a signal from the sensor arranged to detect the inclination after stretching of the arm. During stretching of the arm, since acceleration in the horizontal direction is applied to the inclination sensor, it is difficult to correctly measure the inclination. Therefore, during this period, the base is tilted in accordance with the stored tilt angle. At the time of lowering the arm after the arm has been stretched, since only the gravity is applied to the inclination sensor, and the inclination sensor is accelerated only in the direction of gravity (vertical direction), inclination can be measured correctly. Therefore, at the time of lowering the arm, the base is tilted in accordance with the signal from the inclination sensor. In this manner, in the period from stretching of the arm, elevation of the arm, and until unloading of the article, the tip end of the arm can be kept substantially horizontal all the time so as to make it possible to unload the article to a predetermined position.

More preferably, the controller is configured to elevate the arm while tilting the base in accordance with a signal from the sensor arranged to detect the inclination at the time of loading of the article, and retract the arm while tilting the base in accordance with a stored tilt angle after elevation of the arm. In this manner, during the period from loading of the article until transportation of the article onto the base, the tip end of the arm can be kept substantially horizontal all the time.

In a preferred embodiment of the present invention, a tiltable base and an arm configured to be elevated, lowered, stretched, and retracted on the base are provided, and an article is transferred by performing by the steps of a) detecting inclination at a tip end of the arm using a sensor, and tilting the base to cancel the detected inclination, and b) measuring a position of the article on the arm, and correcting a stretching amount of the arm in accordance with the measured position of the article on the arm.

Preferably, the step (a) is performed at the time of elevating or lowering the arm, and the step (c) of tilting the base in accordance with a stored tilt angle is performed at the time of stretching or retracting the arm.

In the present specification, the description regarding the transfer apparatus is directly applicable to the transfer method, and conversely, the description regarding the transfer method is directly applicable to the description regarding the transfer apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a plan view showing main components of a transfer apparatus according to a preferred embodiment of the present invention.

FIG. 2 is a side view showing main components of the transfer apparatus according a preferred embodiment of the present invention.

FIG. 3 is a block diagram showing an inclination sensor used in a preferred embodiment of the present invention.

FIG. 4 is a block diagram showing a controller included in a preferred embodiment of the present invention.

FIG. 5 is a flow chart showing a loading algorithm used in a preferred embodiment of the present invention.

FIG. 6 is a flow chart showing an unloading algorithm used in a preferred embodiment of the present invention.

FIG. 7 is a side view schematically showing a support member and an article at the time of unloading.

### DETAILED DESCRIPTION OF THE PREFERRED EMBODIMENTS

Hereinafter, preferred embodiments for carrying out the present invention in the most preferred form will be described. The scope of the present invention shall be determined according to the understanding of a person skilled in the art based on the description of the claims in consideration of the description of the specification and techniques known in this technical field.

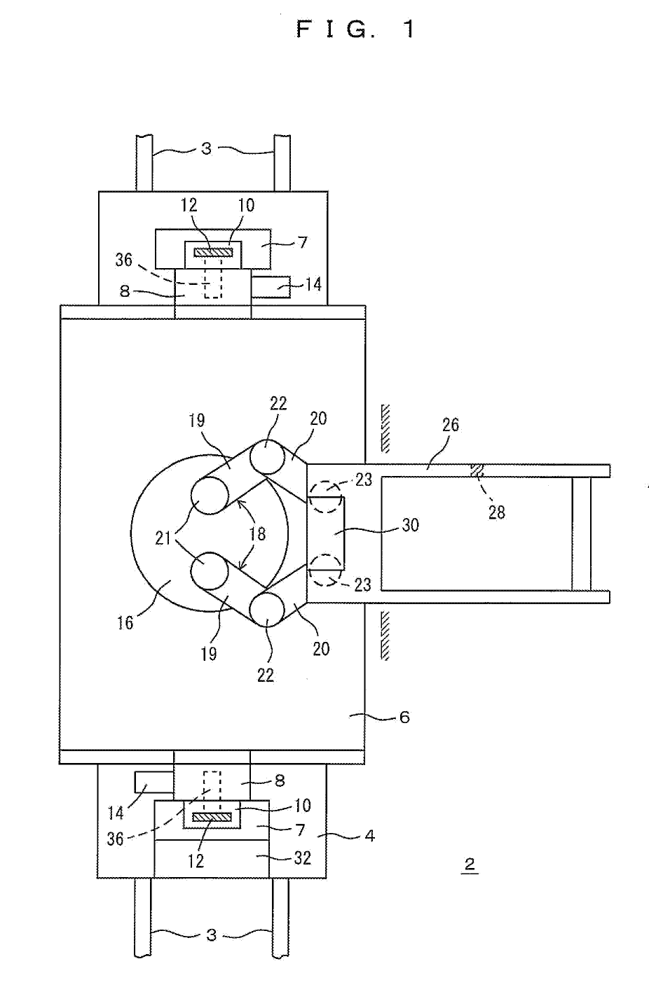

FIGS. 1 to 7 show a stacker crane 2 taken as an example of a transfer apparatus according to a preferred embodiment of the present invention. A transfer apparatus according to a preferred embodiment of the present invention may be mounted in an automatic transportation vehicle, an overhead traveling vehicle or the like, for example. Alternatively, instead of mounting the transfer apparatus in the vehicle, a body of the transfer apparatus may be attached to a tiltable base provided on a station or the like, for example. In the drawings, a reference numeral 2 denotes a stacker crane that travels on travel rails 3. A reference numeral 4 denotes vehicle, and a reference numeral 6 denotes an elevation platform that is elevated and lowered along a mast 7. Reference numerals 8 denote a frame, e.g., provided on front and back sides of the elevation platform 6. Reference numerals 10 denote guided members, and each of the guided members 10 is connected to the frame 8 through a pivot central shaft 34 and a tilt shaft 36 described later. The guided members 10 are guided by the mast 7, and elevated and lowered by elevation members 12 such as chains, belts, or ropes. Reference numerals 14 denote tilt motors arranged to control an inclination angle (tilt angle) of the elevation platform 6 relative to a horizontal plane.

For example, a turntable 16 is provided on the elevation platform 6, and a pair of SCARA arms 18 are mounted on the turntable 16. Reference numerals 19, 20 denote arms of the SCARA arms 18, and reference numerals 21 to 23 denote shafts. A reference numeral 26 denotes a hand attached to distal ends of the pair of the SCARA arms 18. Instead of the SCARA arms 18, for example, a slide fork may be used. The turntable 16 may not be provided. The hand 26 supports the article in an area on the right side of a dotted line in FIG. 1. The area for supporting the article is referred to as the tip end. A reference numeral 28 denotes an inclination sensor provided at the tip end of the hand 26 to measure inclination from the horizontal plane. A reference numeral 30 denotes an article position sensor arranged to measure a position of the article on the hand 26. For example, a laser distance sensor may be used as the article position sensor 30. A reference numeral 32 denotes a controller of the stacker crane 2.

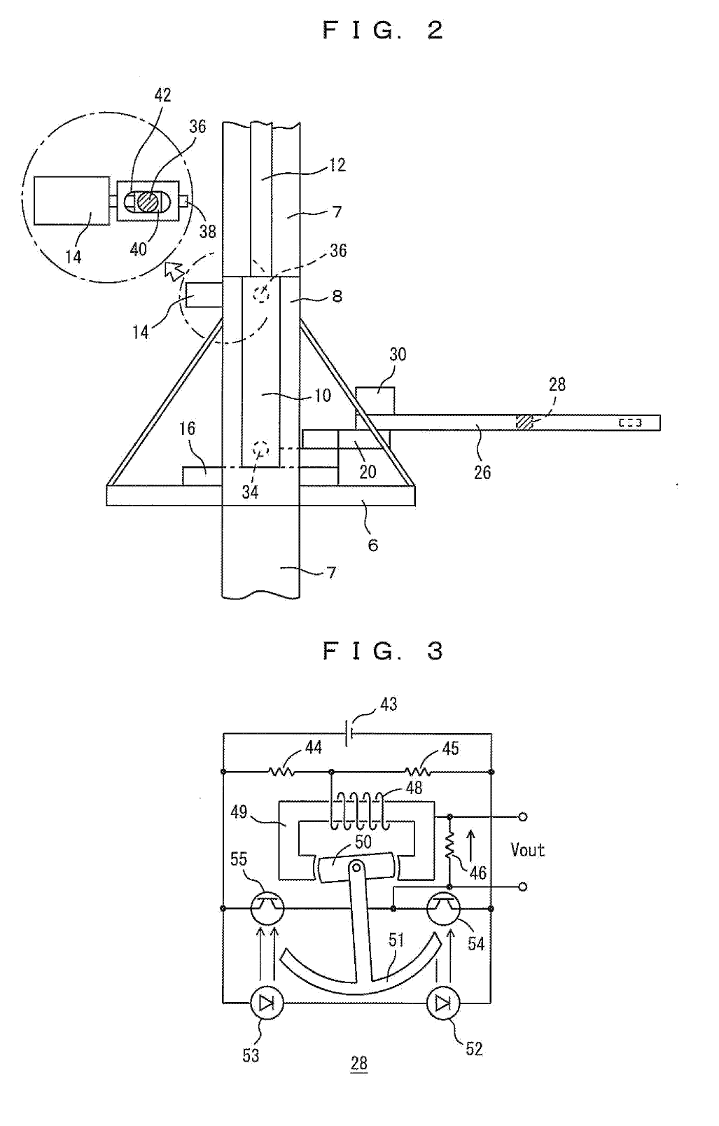

FIG. 2 shows a tilt mechanism of the elevation platform 6. The frame 8 is connected to the guided member 10 at one of upper and lower positions of the tilt mechanism. The frame 8 is pivotable about the pivotal shaft 34. A tilt shaft 36 is fixed to the other of the upper and lower positions of the guided member 10. As shown in an upper left portion in FIG. 2, the tilt shaft 36 is movable to the left and right within a long hole 42 provided in the frame 8. The tilt shaft 36 is connected to a ball screw 38 attached to a tilt motor 14 through a nut 40. In this manner, the tilt shaft 36 can move relative to the long hole 42 by the tilt motor 14. Since the elevation platform 6 is pivotable about the pivot central shaft 34, the elevation platform 6 can be inclined (tilted) toward the left or right in FIG. 2. The tilt mechanism is not limited to the mechanism shown in FIG. 2. For example, by supporting four corners of the elevation platform 6 by the elevation members, and by feeding the elevation members on the left and right sides of the elevation platforms 6 by different amounts, the elevation platform 6 is tilted. In the present preferred embodiment, the transfer apparatus includes the elevation platform 6, components on the elevation platform 6 such as the SCARA arms 18, the tilt mechanism, and the elevation mechanism of the elevation platform 6.

FIG. 3 shows structure of the inclination sensor 28. A reference numeral 43 denotes a power supply, and reference numerals 44 to 46 denote resistors. Among the resistors 44 to 46, the voltage of the resistor 46 is outputted. A reference numeral 48 denotes a coil, a reference numeral 49 denotes a yoke made of magnetic material, a reference numeral 50 denotes a rotor made of magnetic material. When the coil 48 is energized, the rotor 50 is induced to be in alignment with the yoke 49. A shield plate 51 is attached to the rotor 50 in the direction of gravity. When the inclination sensor 28 is inclined, due to gravity, the shield plate 51 and the rotor 50 move together to the left or right. Reference numerals 52, 53 denote LEDs, and reference numerals 54, 55 denote phototransistors. Photodiodes or the like may be used instead of the phototransistors. When the inclination sensor 28 is inclined, the shield plate 51 is tilted, and light from one of the LEDs 52, 53 is interrupted. When the light is interrupted, resistance of one of the phototransistors 54, 55 is increased, and electrical current flows through the coil 48 and the resistor 46. By the electrical current flowing through the coil 48, inclination of the rotor 50 and the shield plate 51 is eliminated, and a feedback for the inclination by the gravity of the shield plate 51 is provided. As a result, the electrical current flowing through the resistor 46 becomes substantially proportional to the inclination angle of the inclination sensor 28. The inclination sensor 28 is not limited to a sensor arranged to detect inclination of the pendulum (shield plate 51) due to gravity. Alternatively, a sensor having a moving element moving along a circular arc route in a vertical plane, and detecting the position of the moving element may be adopted. It is desirable to damp vibration of the moving element by providing a feedback to cancel inclination of the moving element, specifically by energizing the coil 48 and attracting the moving element by the yoke 49.

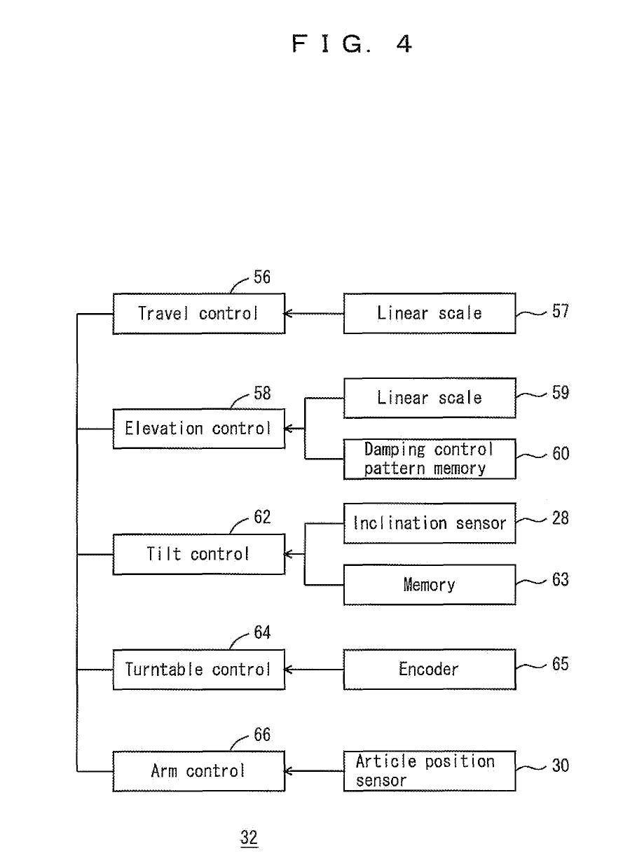

FIG. 4 shows a controller 32 of the stacker crane 4. A travel controller 56 controls travel of the vehicle, and uses data of a position of the vehicle in a traveling direction, measured by a linear scale 57. An elevation controller 58 uses height data of the elevation platform 6, e.g., measured by a linear scale 59 to elevate or lower the elevation platform 6, and thus, elevate or lower the arms. Further, the elevation controller 58 elevates or lowers the elevation platform 6 to cancel (offset) the change at the position of the tip end of the arm due to vibration. Any type of sensor can be used for measuring the position of the vehicle in the travel direction and the position in the height direction. At the time of stretching or retracting the SCARA arms 18, the elevation controller 58 implements damping control by elevating or lowering the elevation platform 6, e.g., in accordance with data in a damping control pattern memory 60 to damp vibration at the tip end of the hand. The damping control reduces vibration caused by, e.g., tilt control by a tilt motor, stretching and retraction of SCARA arms, and the change in the load by the transfer of the article. The tilt controller 62 implements tilt control to keep the tip end of the hand horizontal using a signal from the inclination sensor 28. At the time of stretching or retracting the arms, since acceleration is applied to the inclination sensor 28 in the horizontal direction, it is difficult to obtain data of the correct inclination angle. Therefore, the tilt is corrected in accordance with a pattern stored in a memory 63 for each of the cases where any article is present and no article is present. A turntable controller 64 controls a turntable based on a signal from an angle sensor such as an encoder 65. An arm controller 66 stretches and retracts the SCARA arms based on a signal from the article position sensor 30 to determine the stretching amount of the arms at the time of unloading the article.

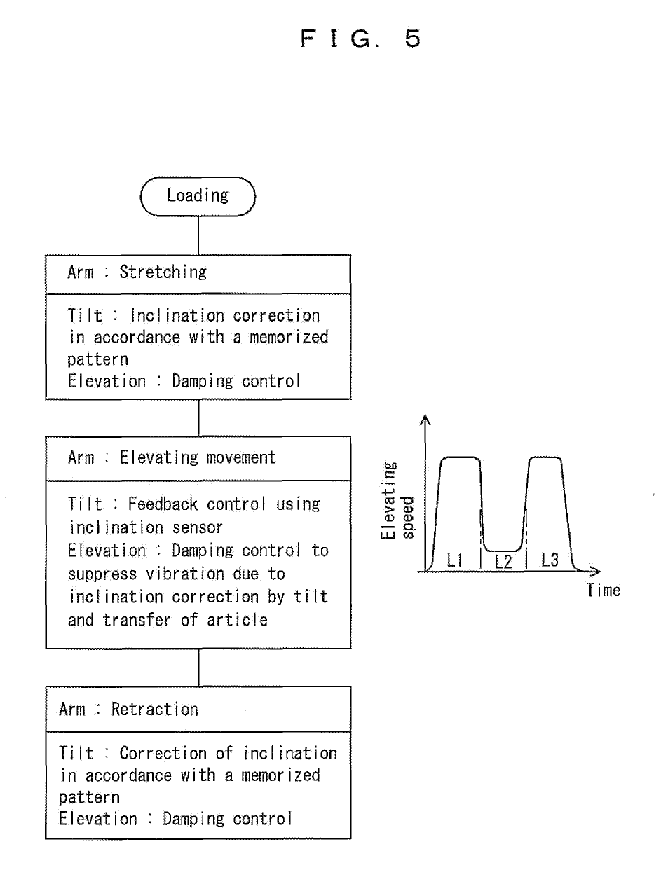

FIG. 5 shows control at the time of loading an article. During stretching of the arms, since acceleration in the horizontal direction is applied, it is difficult to obtain correct data from the inclination sensor. Therefore, tilt control of the elevation platform is implemented in accordance with a pattern stored in a memory, and inclination at the tip end of the arms is eliminated. Further, since the tip end of the arms is vibrated in a vertical direction as a result of tilt control and stretching of the arms, damping control in the elevation direction is implemented by elevating or lowering the elevation platform for damping vibration at the tip end of the arms.

After the end of stretching of the arms, the arms are elevated by elevating the elevation platform. As shown on the right side of FIG. 5, elevation of the arms occur in a segment L1 having a large elevating speed, a segment L2 having a small elevating speed for loading an article from a support member, and a segment L3 having a large elevating speed after the segment L2. In the segments L1 to L3, since no acceleration is applied in the horizontal direction, by determining an inclination angle using the inclination sensor to implement feedback control of the tilt shaft, inclination is corrected to keep the tip end of the arms (tip end of the hand) horizontal. By operation of the tilt shaft and the change in the load due to transfer of the article, vibration occurs at the tip end of the arms. Therefore, the elevation platform is elevated or lowered to cancel the vibration.

Also at the time of retracting the arms, since acceleration in the horizontal direction is applied, it is difficult to accurately determine the inclination angle by the inclination sensor. Therefore, the tilt shaft is controlled in accordance with a pattern stored in the memory. The stored pattern for the tilt control in the case where any article is present is different from the stored pattern in the case where no article is present. Further, the stored pattern at the time of stretching the arms is different from the stored pattern at the time of retracting the arms. As the stored pattern, a tilt angle is stored for every stretching amount of the arms. The elevation platform is elevated or lowered to cancel vibration at the tip end of the arms due to the control of the tilt shaft and retraction of the arms.

In the present preferred embodiment, the inclination angle at the tip end of the arms can be measured over the entire range at the time of elevating and lowering the arms. However, in the case of reading marks of the support member using an optical sensor, the tilt angle can be detected only in narrow segments. Therefore, in the other segments, since feedback control cannot be implemented in a manner to eliminate the inclination angle, the arms and the article may contact at a line not on a plane, or the article after loading may contact the support member.

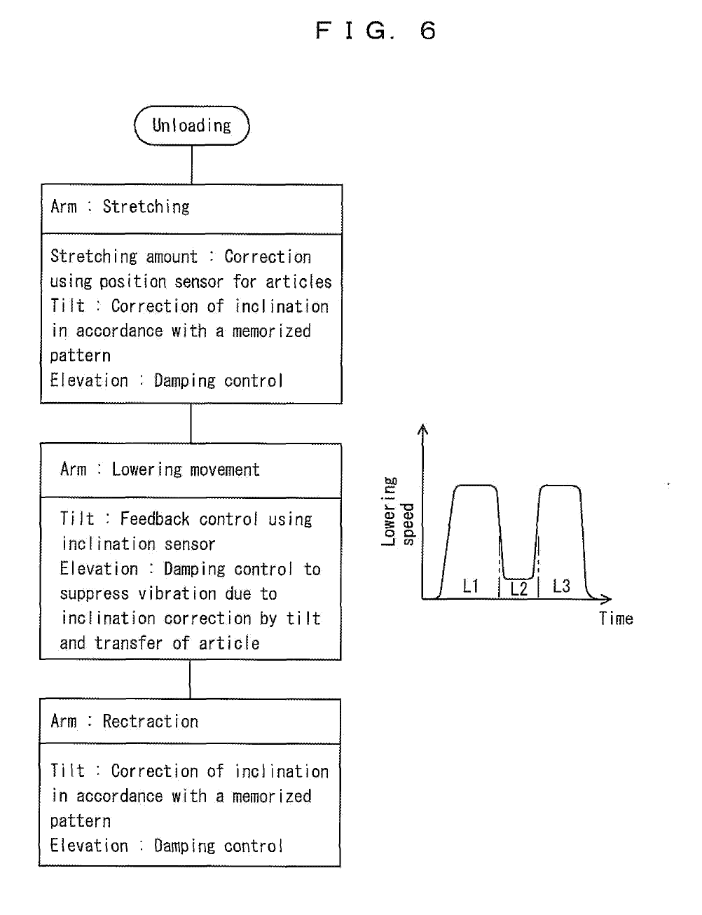

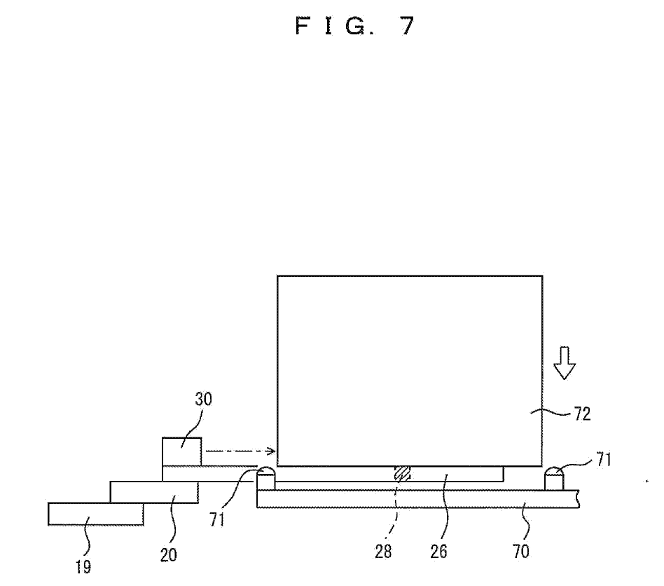

FIG. 6 shows control of unloading an article. At the time of loading the article by the arms, or at the time of unloading the article from the arms, based on the distance to the article measured by the article position sensor, the stretching amount of the arms is corrected. Thus, in FIG. 7, the article 72 can be unloaded to a predetermined position of a support member 70 in a length direction. The tip end is inclined due to stretching of the arms. However, since acceleration is applied in the horizontal direction, it is difficult to determine the inclination angle using the inclination sensor. Therefore, the inclination angle is corrected in accordance with a stored pattern in the memory. In the elevation controller, damping control is implemented by elevating or lowering the elevation platform to cancel vibration at the tip end of the arms. The damping control may be omitted.

At the time of unloading the article by lowering the elevation platform to lower the arms, as in the case of FIG. 5, different lowering speeds are used in the three segments L1, L2, and L3. In each segment, feedback control of the tilt shaft is implemented based on the inclination angle determined by the inclination sensor. Through the feedback control, the tip end of the arms is kept horizontal. Damping control is implemented by the elevation controller to cancel the vibration by operation of the tilt shaft and the vibration at the tip end of the arms due to transfer of the article. At the time of retracting the arms, inclination is corrected in accordance with the stored pattern for the case of retracting the arms without any article. Thus, the tilt shaft is controlled, and vibration control is implemented to cancel vibration at the tip end of the arms.

In FIG. 7, the reference numeral 70 denotes the support member, and a reference numeral 71 denotes a guide such as a ball like roller. At the time of unloading the article 72, when the arms are not present at predetermined positions, the arms are guided by the guide 71. For example, the article 72 is a case of a flat panel such as a liquid crystal panel or a plasma panel. However, any article can be the target of transfer in the embodiment. Since the article position sensor 30 measures the distance to article 72 on the hand 26, the article can be unloaded to a predetermined position of the support member 70 in the depth direction. In particular, when the article 72 is moved repeatedly in a warehouse, positional deviation of the article 72 relative to the hand 26 is accumulated to cause a large cumulative deviation (error). However, in the present preferred embodiment, since the positional deviation is eliminated each time unloading of the article is carried out, the positional deviation is not accumulated. Further, since the inclination sensor 28 measures inclination at the tip end of the hand 26, and eliminates inclination by operating the tilt shaft, the article 72 does not collide with components such as the guide 71. Therefore, the article 72 can be unloaded to a correct position without applying impact or the like to the article 72. Further, the unloading position of the article 72 can be kept correctly.

In the present preferred embodiment, though the laser distance sensor is used as the article position sensor 30, any sensor can be used as long as it can measure the distance to the article 72. The position of the article position sensor 30 is not limited to the rear end of the hand 26. Though the inclination sensor 28 is provided at the tip end of the hand 26 (portion for supporting the load of the article 72), the inclination angle based on the elevation platform may be measured, e.g., using a camera provided in the elevation platform. In the present preferred embodiment, damping control is implemented at the time of retracting the arms without having any article after unloading and at the time of stretching the arms without having any article before loading. However, the damping control for the arms without having any article may be omitted. Further, the damping control may entirely be omitted.

### DESCRIPTION OF THE NUMERALS

2: stacker crane
3: travel rail
4: vehicle
6: elevation platform
7: mast
8: frame
10: guided member
12: elevation member
14: tilt motor
16: turntable
18: SCARA arm
19, 20: arm
21 to 23: shaft
26: hand
28: inclination sensor
30: position sensor for articles
32: controller
34: pivotal shaft
36: tilt shaft
38: ball screw
40: nut
42: long hole
43: power supply
44 to 46: resistor
48: coil
49: yoke
50: rotor
51: shield plate
52, 53: LED
54, 55: phototransistor
56: travel controller
57, 59: linear scale
58: elevation controller
60: damping control pattern memory
62: tilt controller
63: memory
64: turntable controller
65: encoder
66: arm controller
70: support member
71: guide
72: article

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A transfer apparatus comprising:
a tiltable base;
an arm configured to be elevated, lowered, stretched, and retracted on the base;
a sensor arranged to detect inclination at a tip end of the arm;
a sensor arranged to measure a position of an article on the arm; and
a controller arranged to tilt the base to cancel a detected inclination and to correct a stretching amount in correspondence with a measured position of the article on the arm.

2. The transfer apparatus according to claim 1, further comprising an inclination sensor arranged to detect inclination of a moving element of the inclination sensor caused by gravity, at a tip end of the arm.

3. The transfer apparatus according to claim 1, wherein the controller is configured to stretch the arm in correspondence with the position of the article on the arm at a time of unloading the article, tilt the base in accordance with a stored tilt angle during stretching of the arm, and lower the arm while tilting the base in accordance with a signal from the sensor to detect the inclination after stretching of the arm.

4. The transfer apparatus according to claim 3, wherein the controller is configured to elevate the arm while tilting the base in accordance with a signal from the sensor to detect the inclination at a time of loading of the article, and retract the arm while tilting the base in accordance with a stored tilt angle after elevation of the arm.

5. A method of transferring an article by providing a tiltable base and an arm configured to be elevated, lowered, stretched, and retracted on the base, the method comprising the steps of:
a) detecting inclination at a tip end of the arm using a sensor, and tilting the base to cancel the detected inclination; and
b) measuring a position of the article on the arm, and correcting a stretching amount of the arm in accordance with the measured position of the article on the arm.

6. The transfer method according to claim 5, wherein the step (a) is carried out at a time of elevating or lowering the arm, and the method further comprises the step (c) of tilting the base in accordance with a stored tilt angle at a time of stretching or retracting the arm.
